(19) United States
(12) Patent Application Publication
(10) Pub. No.: US 2012/0232700 A1
(43) Pub. Date: Sep. 13, 2012

(54) METHOD FOR CONTROLLING ROOM AUTOMATION SYSTEM

(75) Inventors: Thomas BALMER, Zug (CH); Joerg Hammer, Hunenberg (CH)

(73) Assignee: Siemens Aktiengesellschaft

(21) Appl. No.: 13/414,424

(22) Filed: Mar. 7, 2012

(30) Foreign Application Priority Data
Mar. 7, 2011 (EP) 11157236

(51) Int. Cl. G05D 23/19

(52) U.S. Cl. 700/276

(57) ABSTRACT

User acceptance of energy-optimized room automation can be improved by determining a first value which is a measure of the utilization of the energy used for holding the comfort variable in the comfort band predetermined for the comfort variable in a first operating mode of a room automation system, detecting an event initiated by a user, through which the operating mode of the system is changed, determining a second value which includes a measure for change of energy utilization for keeping the comfort variable in the comfort band applicable for the comfort variable in the changed operating mode of the system, determining a comparison value through which a relationship between the first value and the second value is able to be quantified, and evaluating the comparison value and correspondingly updating information provided to the user in relation to the current utilization of the energy used for the comfort variable.

### CROSS REFERENCE TO RELATED APPLICATIONS

This application is based on and hereby claims priority to European Application No. 11157236 filed on Mar. 7, 2011, the contents of which are hereby incorporated by reference.

### BACKGROUND

Described below is a method for controlling a room automation system for controlling or regulating at least one room comfort variable in a building.

Such methods are typically suitable for demand-driven heating, cooling, ventilation, illumination and shading of rooms or zones in buildings and are typically implemented in a building automation system.

For heating, cooling, ventilation and illumination of the building energy suitable for the purpose is needed, the costs of which arise directly in its provision, processing or storage and on the other hand in the removal or mitigation of undesired ancillary effects. These energy costs are generally dependent on time. Thus for example procurement of a fuel at a certain point in time can be relatively low-cost. When the fuel is burned however gases and particles can occur which for example result in taxes or payments to the state or which cost money to filter, so that this fuel overall is not a low-cost form of energy for heating. Typically solar heat radiated through windows or the shell of the building and sunlight entering through windows are low-cost energies, while heat generated by heating oil or cool air generated with electricity are cost-intensive energies. In addition cost-intensive energy can also mean that the consumption of the corresponding energy causes higher costs, meaning that the system is less economical. Basically there is a desire to design the mode of operation of a building automation system so that the energy costs for a certain level of comfort required in the building, in respect of temperature, air quality and illumination, can be minimized as far as possible over a longer time horizon.

Methods and systems for controlling and/or for regulating room comfort variables such as temperature, air humidity, air quality and illumination intensity in a building are known in a plurality of variants.

Such methods are known for example from the publications EP 1 074 900A, WO2007/042371A and WO2007/096377A in which it is proposed to use a model-predictive device in order to optimize the energy consumption or the energy costs for a certain level of room comfort.

In addition in WO2009/124217A a building automation system is disclosed through which air-quality, light fixtures and blinds are able to be controlled and/or regulated in the optimum way.

Known methods of operation of building automation systems through which typically temperature, air quality and illumination intensity in rooms can be regulated or controlled for minimized energy consumption also demand optimum coordination as a function of room occupation in the use of heating and cooling circuits, heat and cold storage, recirculated air, outside air, artificial light fittings and daylight. Within the framework of optimum coordination for example roller blinds or venetian blinds are positioned in accordance with a permitted or desired direction-dependent heat or light flow, which can be associated with disadvantages for users of the building, since for example closed roller blinds or venetian blinds adversely affect the view out of a window. Furthermore on the one hand sufficient fresh outside air can be supplied through an open window to a room, on the other hand however the room temperature in such cases, depending on the prevailing outside temperature, can be influenced unfavorably. Depending on the sensitivities of a user it can be desirable to increase the predetermined target value in winter for them in a room occupied by them or to set the target value lower in summer, which is associated each case as a rule with increased energy consumption and thus with additional costs. Basically the method of operation of a building automation system optimized for minimal energy costs requires a high level of acceptance from the users of the building.

### SUMMARY

Described below is a method for controlling a room automation system through which the user acceptance for the method for optimizing the energy demand required for a specific level of comfort can be significantly improved. The method should be able to be implemented in the building automation system and be able to be carried out automatically through its functionality.

Exemplary embodiments of the invention are explained in greater detail below with the aid of drawings.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a schematic representation of a room with devices for an integrated room automation, and

FIG. 2 is a node diagram for mode of operation of the method.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

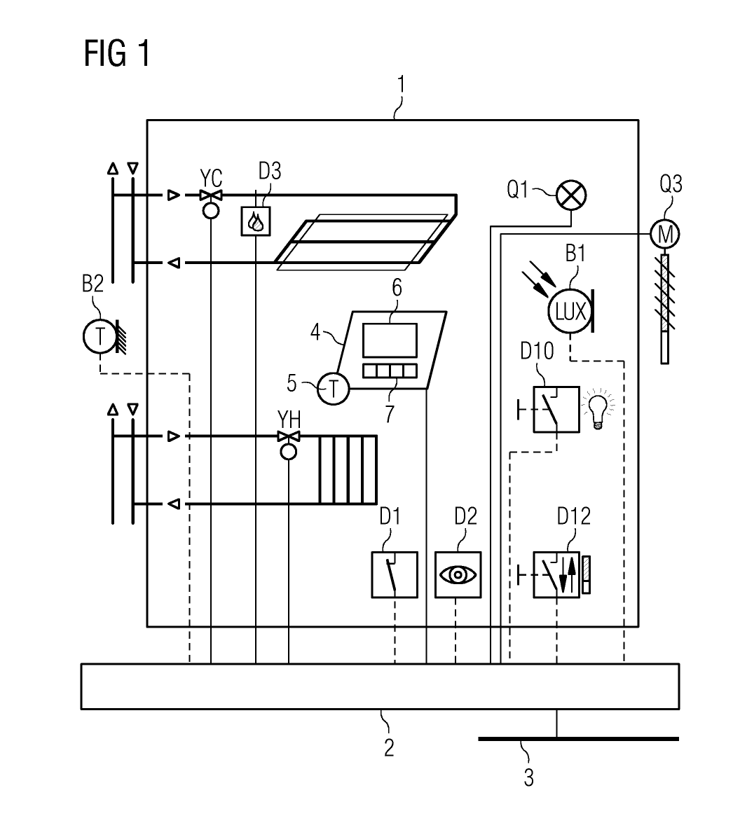

In FIG. 1 the number 1 refers to a room or a room zone in a building. The controllable or regulatable comfort variables in the room 1 include at least the room temperature and if necessary also typically the air humidity, the air quality and the illumination intensity. The controllable or regulatable comfort variables are held with the aid of a control or regulation system 2 by appropriate control and/or regulation with optimized energy outlaying a comfort band assigned to the respective comfort variable. The control and regulation system 2 is part of the building automation system and connected via a bus system 3 to further components of the automation system.

For control and/or regulation of the comfort variables in room 1 the building automation system typically includes a heating system, a cooling system, a ventilation system, a lighting system and a shading system. The example shown in FIG. 1 of an integrated room automation includes just a minimum of structures to present the principle of the method. The method presented for optimum control and regulation of comfort variables is basically able to be easily used even when more or fewer structures are employed. The term structure here includes the totality of the devices, installations and the available and usable energy circuits for heating, cooling, ventilation and illumination to achieve the desired room comfort.

The devices disposed in the room 1 for example are a room device 4, a light sensor B1 for measuring the illumination intensity, a window switch D1, a presence detector D2, an operating unit D12 for manual operation or control of blinds or blind drives Q3, a further operating unit D10 for indirect switching or control of light fittings Q1, a heating valve YH of a heating circuit able to be controlled by the control and regulation system 2, and a cooling valve YC able to be controlled by the control and regulation system 2 as well as a dew point sensor D3 of a cooling circuit. A temperature sensor 5 for measuring the temperature in room 1 is arranged in the room device 4 for example, which has a user interface, for example a display unit 6 and input elements 7.

An outside temperature sensor B2 is arranged outside the building. The structures are connected to the control and regulation system 2 via data communication channels. The data communication channels are implemented using wires or wirelessly in the known manner. If necessary structures can also be electrically supplied via the control and regulation system 2. The cooling circuit here includes a cooling ceiling which is able to be operated at least some of the time with low-cost energy—for example by a cooling tower. The building typically includes a plurality of rooms or room zones.

The room climate variables able to be controlled or regulated with the control and regulation system 2 are typically at least the room temperature T_{R1} of the room 1 and depending on requirements, further variables used for comfort in room 1, such as the illumination intensity, the air humidity, the carbon dioxide content or the proportion of volatile organic contents VOC in the room air.

In a variant the illumination in the room 1 is advantageously regulated by the control and regulation system 2 with the aid of the output signal B1 of the light sensor and a further signal of the presence detector D2 by corresponding activation of the light element Q1 arranged in the room 1 so that at specific locations in the room 1, the illumination intensity then lies in a predetermined comfort band, provided the presence detector detects the presence of people in the room 1.

In a further variant a positioning or radiation transparency of the shading device effective on the windows of the room 8 or 9 is also able to be controlled and/or regulated by the control and regulation device 2. The shading device can be implemented by venetian blinds, roller blinds, shutters or slats for example. A further variant for realizing the shading device is the use of windows with electrically switchable shading or with integrated electrically switchable micro-mirrors.

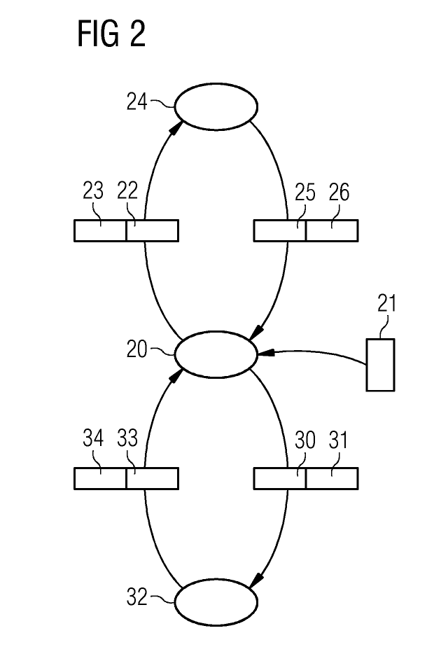

The principal behavior of a room automation system able to be controlled is shown in FIG. 2. The behavior will be explained in greater detail below with reference to an actual example. In the example the temperature in room 1 (FIG. 1) and the illumination intensity of a work station in room 1 will be operated with the lowest possible energy outlay by the control and regulation system 2 basically to a predetermined level of comfort. Because of the intended room utilization a comfort band for the temperature and a further comfort band for the illumination intensity are thus advantageously predetermined. In the example the comfort band for the temperature lies between a lower threshold value of 20° C. and an upper threshold value of 25° C. and the comfort band for the illumination intensity between a lower threshold value of 300 lux and an upper threshold value of 1000 lux.

The number 20 refers to a first mode of operation of the control and regulation system 2. In the first mode of operation 20 the temperature and the illumination intensity in room 1 are held by the control and regulation system 2 in the predetermined comfort bands. In the first mode of operation the control and regulation system 2 operates automatically so that the variables are optimized to a predetermined target. Typically the predetermined target is a good utilization of available energy, i.e. the minimization of the energy costs to achieve the predetermined comfort.

On execution of an initialization routine 21—in a phase of starting up or resetting the room automation system for example—the control and regulation system 2 is set automatically to the first mode of operation 20.

To achieve the desired comfort and the desired optimization target, in the first mode of operation 20 required adjustment or control signals for the heating valve YH, the cooling valve YC, the blinds drive Q3 and the light fitting Q1 are generated by the control and regulation system 2 automatically with optimum coordination between the structures. As part of the optimum coordination for example the venetian blinds or roller blinds are positioned according to a permitted or desired, direction-dependent flow of heat or light.

After the execution of the initialization routine 21 the control and regulation system 2 advantageously operates in the first operating mode 20 until a user intervenes.

As well as the activation of the heating valve YH, the cooling valve YC, the blind drive Q3 and the light fitting Q1 necessary for achieving the desired comfort, the following is carried out by the control and regulation arrangements 2.

A first value is determined which is a measure for the utilization of the energy employed to keep the temperature and the illumination intensity in room 1 in the predetermined comfort bands in the first operating mode 20 for the temperature and the illumination intensity.

Next, operating elements are monitored such that an event initiated by a user is detected through which the operating modes of the system will be changed. Thus in the present example advantageously the control elements able to be operated manually in room 1, namely input elements 7 of the room device 4, the operating unit D10 for manual control of the light fittings, the operating unit D12 for the manual control of roller blinds or venetian blinds and the window switch D1.

A second value is determined which includes a measure for the change of the utilization of the energy employed to keep the comfort variable in the comfort band applicable for the comfort variable in the changed operating mode of the arrangement.

Then, a comparison value is determined through which a relationship between the first value and the second value will be quantified.

The comparison value is evaluated and information given to the user is updated in relation to the current utilization of the energy used for the comfort variable in accordance with the evaluation of the comparison value. The information is for example shown by the display unit 6.

After the evaluation, the user is advantageously requested by a corresponding user interface, for example via the display unit 6, to acknowledge the event initiated by him, for example using the input elements or even to cancel it.

The monitoring carried out by the control and regulation system 2 enables a first event 22 to be detected, if for example a user uses the input elements 7 during a heating period to increase the lower threshold value of the comfort band for the temperature from the predetermined 20° C. to 22° C. In a first process 23 carried out after the first event 22 the second and comparison values are determined and the comparison value is evaluated, then the information is typically output to the user on the display unit 6. Advantageously the first process 23 is concluded and during this time a switch is made into a second operating mode 24. In the second operating mode 24 advantageously there is a wait for a certain period of time for a confirmation on the part of the user as to whether the lower threshold value of the comfort band is actually to be increased at the expense of the expected reduction of the energy efficiency to 22° C. The number 25 designates a second event which corresponds either to the expiry of the period of time for a confirmation or a rejection of the temperature increase on the part of the user. In a second process 26 carried out in response to the second event 25 the control and regulation system is set in the first operating mode 20.

The monitoring carried out by the control and regulation system 2 enables a third event 30 to be detected, if for example a user, during a cooling period, opens the roller blinds by the operating unit 12 held in a position screening out the sun's radiation by the control and regulation system 2, so that a throughflow in the cooling valve YC is to be increased. In a third process 31 carried out in response to the third event 30, the second and comparison values are determined and the comparison value is evaluated, then the information to the user is typically output on the display unit 6. Advantageously the third process 31 is concluded and when this is done a switch is made to a third operating mode 32. In the third operating mode 32 advantageously there is a wait for a certain period of time for a confirmation on the part of the user as to whether the roller blinds are actually to remain open at the expense of the expected reduction in the energy efficiency. The number 33 designates a fourth event, which corresponds either to the expiry of the period of time for a confirmation or to a rejection of the manipulation undertaken by the user. In a fourth process 34 carried out in response to the fourth event 33 the roller blinds are automatically reset to the optimum position and the control and regulation system is set to the first operating mode 20.

The monitoring carried out by the control and regulation system 2 advantageously enables all events able to be initiated by a user to be detected, through which the energy efficiency of the room automation system could be significantly influenced, as well as the events already mentioned, an opening of a window, by the corresponding window switch D1 being monitored or a change in the time intervals in which a reduced comfort, for example a reduction of the room temperature in the night, or increased comfort is provided, in that the input elements 7 of the room device 4 are monitored.

The method presented is able to be expanded in its effect in that for example the utilization of the energy in relation to the room 1 is updated over a certain period as a bonus-malus system. A user of the room 1 can for example obtain a bonus if, in a heating period, he sets a threshold of the comfort band predetermined for the temperature lower or accordingly in a cool period he sets an upper threshold of the comfort band specified for the temperature higher.

The system also includes permanent or removable storage, such as magnetic and optical discs, RAM, ROM, etc. on which the process and data structures of the present invention can be stored and distributed. The processes can also be distributed via, for example, downloading over a network such as the Internet. The system can output the results to a display device, printer, readily accessible memory or another computer on a network.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

What is claimed is:

1. A method for controlling a room automation system, with a system for controlling or regulating at least one comfort variable in a room or in a room zone, operable in at least two modes, in a first operating mode a comfort variable is automatically held for optimized energy consumption in a comfort band predetermined for the at least one comfort variable and in a second operating mode information relating to current energy consumption is generated for a state currently applicable in the room or in the room zone, said method comprising:
determining a first value which is a measure of utilization of energy used for holding the comfort variable in the comfort band predetermined for the comfort variable in the first operating mode of the system;
detecting an event initiated by a user through which the operating mode of the system is changed to a new operating mode;
determining a second value which includes a measure for a change of the utilization of the energy used to keep the comfort variable in the comfort band applicable for the comfort variable in the new operating mode of the system;
determining a comparison value through which a relationship between the first value and the second value is able to be quantified and
evaluating the comparison value and correspondingly updating information provided to the user relating to current utilization of the energy used for the comfort variable.

2. The method as claimed in claim 1, wherein the comfort variable is room temperature able to be detected by a temperature sensor arranged in the room.

3. The method as claimed in claim 2, wherein a further comfort variable is illumination intensity able to be detected by a light sensor arranged in the room.

4. The method as claimed in claim 3, wherein the event initiated by the user through which the operating mode of the system is changed, is a change of the comfort band.

5. The method as claimed in claim 3, wherein the event initiated by the user through which the operating mode of the system is changed, is switching of a window switch.

6. The method as claimed in claim 3, wherein the event initiated by the user through which the operating mode of the system is changed is the actuation of an operating unit for roller blinds, venetian blinds or a device for changing the spectral transparency of a window.

7. The method as claimed in claim 3, wherein the event initiated by the user through which the operating mode of the arrangement is changed is a change to the intended occupancy time for the room.

8. The method as claimed in claim 7, wherein the information provided to the user is shown on a display unit of a room device4).

9. The method as claimed in claim 8, wherein the utilization of the energy in relation to the room is updated over a period of time as a bonus-malus system.

10. The method as claimed in claim 3, further comprising requesting the user to acknowledge the event that was initiated.

11. The method as claimed in claim 3, further comprising requesting the user to cancel the event that was initiated.
